(19) United States
(12) Patent Application Publication
(10) Pub. No.: US 2025/0265469 A1
(43) Pub. Date: Aug. 21, 2025

(54) TRAINING METHODOLOGY FOR DEEP FORWARD-BACKWARD STOCHASTIC DIFFERENTIAL EQUATIONS WITH APPLICATIONS TO DEEP GENERATIVE MODELING

(71) Applicant: Robert Bosch GmbH, Stuttgart (DE)

(72) Inventors: Marcus A. Pereira, Pittsburgh, PA (US); Azari Bahare, Sunnyvale, CA (US); Myeongseob Ko, Sunnyvale, CA (US); Henry Li, Cambridge, MA (US); Filipe Condessa, Pittsburgh, PA (US)

(21) Appl. No.: 18/583,241

(22) Filed: Feb. 21, 2024

(51) Int. Cl. G06N 3/0895

(52) U.S. Cl. CPC G06N 3/0895

(57) ABSTRACT

A clean example to be learned is sampled, the clean example being from an input set of training data to be used to train the generative model. Initial values are computed using the sampled clean example and the generative model. The initial values from the clean example and the computed initial values are fed to a Reversible-Heun (RH) Stochastic Differential Equation (SDE) solver to forward propagate using Schrodinger Bridge Forward-Backward Stochastic Differential Equations (SB-FBSDEs) computed for the generative model, producing predicted output values. A loss function is computed to compare the initial values and the predicted output values. A reverse of the reversible Heun SDE solver is used for, solving the stochastic adjoint SDE to compute the gradient and update the weights of the generative model.

### TECHNICAL FIELD

Aspects of the disclosure relate to a novel training methodology for deep Forward-Backward Stochastic Differential Equations (FBSDEs), with applications in deep generative modeling.

### BACKGROUND

A deep FBSDE framework may use deep neural networks, such as Long-Short Term Memory Units (LSTMs), in a discretize-then-optimize manner to solve systems of FBSDEs which are derived from the corresponding Hamilton-Jacobi-Bellman (HJB) Partial Differential Equations (PDEs). A main drawback of this method is the discretize-then-optimize approach has a memory complexity of O(N), where N is the number of time steps in the Stochastic Optimal Control (SOC) problem. This can lead to Out-Of-Memory (OOM) problems, gradient-vanishing and gradient-exploding problems for tasks which have long time horizons.

It has been proposed to solve Schrodinger Bridge (SB) problems by converting the associated SB-PDEs into Stochastic Differential Equations (SDEs). The SDEs may then be solved using deep neural networks using different algorithms. A first algorithm is based on a discretize-then-optimize approach, which still suffers from memory issues for long time horizon tasks. A second algorithm utilizes a memory buffer to store past trajectory data but loses gradient information because of discarding the associated computational graphs. The latter approach results in some terms of the proposed loss function becoming non-differentiable or constant with respect to the weights of the network(s).

### SUMMARY

In one or more illustrative examples, a method for training a Schrodinger-Bridge-based generative model is provided. A clean example to be learned is sampled, the clean example being from an input set of training data to be used to train the generative model. Initial values, for the scalar fields described by the Schrodinger-Bridge PDE, are computed using the sampled clean example by feeding it to the corresponding sub neural-networks of the generative model. The computed initial values are then fed to a Reversible-Heun (RH) Stochastic Differential Equation (SDE) solver to forward propagate the Schrodinger Bridge Forward-Backward Stochastic Differential Equations (SB-FBSDEs) for a fixed number of steps, producing predicted output values of the scalar fields. The forward propagation of each scalar field relies on outputs from other sub neural networks of the generative model. A loss function is computed to compare the predicted output values and the expected true output values. The RH SDE solver is then used in the reverse direction to compute the gradient of the loss function with respect to the weights of the deep generative model and to update the weights of all the sub neural networks that comprise the deep generative model. This is possible because of the algebraic reversibility property of the RH SDE solver that can provide gradients to the same level of accuracy as discretize-then-optimize methods without incurring the O(N) memory complexity.

In one or more illustrative examples, the clean example is a two-dimensional image.

In one or more illustrative examples, the Nonlinear Feynman-Kac lemma is utilized to obtain the SB-FBSDEs corresponding to Schrodinger Bridge Partial Differential Equations (SB-PDEs) for the generative modeling problem.

In one or more illustrative examples, any state-of-the-art variant of the Stochastic Gradient Descent (SGD) deep learning optimizer is used to update the weights of the deep generative model by using the gradients computed using the RH SDE solver. In one or more illustrative examples, the SGD-based deep learning optimizer is the Adam optimizer.

In one or more illustrative examples, the training is repeated a plurality of times until convergence.

In one or more illustrative examples, the generative model is used, once trained, for generating a data sample.

In one or more illustrative examples, the trained Schrodinger-Bridge-based generative model is used for outlier generation by finding a starting point drawn from a prior distribution that leads to a data point with low data likelihood. This process also leverages the algebraic reversibility of the RH SDE solver.

In one or more illustrative examples, the starting point is found by using a loss function that evaluates the data log likelihood of the generated sample.

In one or more illustrative examples, the starting point is found by using a learned data log-likelihood loss function of the Schrodinger-Bridge-based generative model directly as a classifier of outlier status based on a predefined outlier threshold value.

In one or more illustrative examples, the data log-likelihood is used in a typicality test-based outlier detection scheme applied to multi-data point queries.

In one or more illustrative examples, a system for training a Schrodinger-Bridge-based generative model includes one or more computing devices configured to sample a clean example to be learned, the clean example being from an input set of training data to be used to train the generative model; compute initial values for the scalar fields described by the Schrodinger-Bridge PDE using the sampled clean example and the corresponding sub neural-networks of the generative model; feed the computed initial values to a RH SDE solver to forward propagate the SB-FBSDEs for a fixed number of steps, producing predicted output values of the scalar fields; compute a loss function that compares the predicted output values and the expected true output values; and using a reverse algorithm of the RH SDE solver, compute the gradient of the loss function with respect to the weights of the generative model and to update the weights.

In one or more illustrative examples, the clean example is a two-dimensional image.

In one or more illustrative examples, the one or more computing devices are further configured to utilize the Nonlinear Feynman-Kac lemma to obtain the SB-FBSDEs corresponding to SB-PDEs for the generative modeling problem.

In one or more illustrative examples, the one or more computing devices are further configured to use any state-of-the-art variant of the SGD deep learning optimizer to update the weights of the deep generative model using the gradients computed by the reverse algorithm of the RH SDE solver.

In one or more illustrative examples, the SGD deep learning optimizer is the Adam optimizer.

In one or more illustrative examples, the one or more computing devices are further configured to repeat the training a plurality of times until convergence.

In one or more illustrative examples, the one or more computing devices are further configured to use the generative model, once trained, for generating a data sample.

In one or more illustrative examples, the one or more computing devices are further configured to use the trained Schrodinger-Bridge-based generative model for outlier generation by finding a starting point drawn from a prior distribution that leads to a data point with low data likelihood.

In one or more illustrative examples, the starting point is found by using a loss function that evaluates the data log likelihood of the generated sample.

In one or more illustrative examples, the starting point is found by using a learned data log-likelihood loss function of the Schrodinger-Bridge-based generative model directly as a classifier of outlier status based on a predefined outlier threshold value.

In one or more illustrative examples, the one or more computing devices are further configured to use the data log-likelihood in a typicality test-based outlier detection scheme applied to multi-data point queries.

In one or more illustrative examples, a non-transitory computer-readable medium includes instructions for training a Schrodinger-Bridge-based generative model that, when executed by one or more computing devices, cause the one or more computing devices to perform operations including configured to sample a clean image, the clean image being from an input set of training data to be used to train the generative model; compute initial values using the sampled clean image and sub neural networks of the generative model; feed the initial values from the clean image and the computed initial values to a RH SDE solver to forward propagate the SB-FBSDEs computed for the generative model, producing predicted output values; compute a loss function that compares the initial values and the predicted output values; and using a reverse algorithm of the RH SDE solver, solve the stochastic adjoint SDE to compute the gradient and update the weights of the generative model.

### BRIEF DESCRIPTION OF THE DRAWINGS

FIG. 1 illustrates an example process for training a Schrodinger-Bridge-based generative model;

FIG. 2 illustrates an example process for generating data using a trained Schrodinger-Bridge-based generative model;

FIG. 3 illustrates an example process for using a trained Schrodinger-Bridge-based generative model for outlier generation;

FIG. 4 illustrates an alternate example process for using a trained Schrodinger-Bridge-based generative model for outlier generation;

FIG. 5 illustrates yet another example process for using a trained Schrodinger-Bridge-based generative model for outlier generation;

FIG. 6 depicts a schematic diagram of an interaction between a computer-controlled machine and a control system;

FIG. 7 illustrates an example manufacturing system for use in anomaly detection and/or generation of synthetic anomalous data; and

FIG. 8 depicts a schematic diagram of a control system configured to control a robotic assistant.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Aspects of the disclosure relate to a novel framework to solve FBSDEs using deep learning. This approach has applications in safe and distributed stochastic optimal control of autonomous and multi-agent systems (such as swarms of robots) when subject to noise or random forcing in the dynamics. Such dynamics also occur in financial systems modeling stock prices as well as in biomechanical systems that model the movement of muscles subject to neural activations. As compared to earlier approaches, the disclosed approach handles much longer time horizons and has better memory efficiency.

A discretize-then-optimize approach and an optimize-then-discretize approach may each be used to solve Neural SDEs for generative modeling. A Reversible-Heun (RH) solver may be introduced, which is an algebraically reversible solver for Stratonovich SDEs. Meaning, the RH solver may be able to reconstruct the n^{th} iteration from the n+1^{th} iteration in closed form. This property means that it is possible to backpropagate through the solve of the SDE, such that the gradients that are obtained are identical to the discretise-then-optimise gradients obtained by auto-differentiating the numerically discretized forward pass. This has the benefit of providing a more accurate gradient computation that discretize-then-optimize approaches provide, while also benefiting from the O(1) (i.e., constant) memory complexity that is used in an optimize-then-discretize approach. Such a solver may be used to solve generative modeling problems for trajectory data. As discussed in detail herein, these techniques may be applied to the solving of FBSDEs.

In one example, the disclosed approach may be used to solve Schrodinger Bridge (SB) problems. Such problems have applications in generative modeling as well as for dataset-to-dataset interpolation. For instance, one application may be training a deep neural network to approximate the distribution of a given dataset, which can then be used to generate novel synthetic samples that were not in the original dataset, but closely resemble the data points from the original dataset with slight variations. This can be used for dataset augmentation which helps to increase the quantity of available training data to train downstream neural networks such as classifiers.

Because the disclosed approach explicitly models the data log-likelihood, this can be used to generate outlier or boundary samples which rarely occur. Absent the disclosed techniques, such outlier or boundary samples may be difficult or very expensive to acquire in practice. Yet such samples are crucial to develop robust deep learning models such as robust classifiers.

The framework explained in this disclosure enables vastly superior data log-likelihood computation speed, achieving O(1) computational and memory complexity versus the O(N) attained in earlier efforts. Fast access to the data log-likelihood further unlocks many downstream applications. For example, this model can be efficiently utilized in neural compression schemes, which can losslessly compress data at much lower bitrates than possible with standard compression techniques. Additionally, this model can also quickly identify unlikely data points, which are essential for low-latency anomaly detection and fraud prevention tasks.

With respect to the operation of the disclosed approach, aspects of the disclosure take advantage of the mathematical theory that connects PDEs to SDEs. Formally, this is achieved through the Nonlinear Feynman-Kac lemma that connects the solution of a PDE with a set of coupled SDEs of which, one evolves forward in time and the other evolves backwards in time. This evolution forwards and backwards in time is the reason for the name “Forward-Backward” Stochastic Differential Equations or FBSDEs. This connection between PDEs and FBSDEs has significant practical benefits, because solving PDEs in high dimensions is generally unscalable and suffers from the well-known curse-of-dimensionality. Intuitively, this means that as the dimensionality of the problem increases, it becomes exponentially expensive to solve the problem.

PDEs occur in many real-life problems such as weather prediction models, computational finance for options pricing, material science, physical sciences and optimal control of autonomous systems. Thus, developing efficient and scalable methods to solve PDEs is crucial to many fields of engineering and technology. By connecting a PDE to a set of FBSDEs, one can instead focus on solving the set of FBSDEs which indirectly provides the solution to the PDE. Solutions to forward SDEs can be easily obtained using Monte-Carlo sampling which in turn can leverage modern Graphics Processing Units (GPUs) to obtain fast and computationally efficient solutions.

Backward SDEs, however, are not as trivial and until recently have required more sophisticated mathematical tools to solve. For example, deep learning may be used to solve backward SDEs. This relies on a key observation that a SDE is a “backward SDE” due to a given terminal condition, which requires one to start from the terminal condition and evolve the SDE backwards in time. However, one can use a neural network to guess the starting point (i.e., the initial condition) of the backward SDE, which then allows that SDE to evolve forward in time. This in turn allows one to use Monte-Carlo sampling to obtain solutions to the SDE starting from the initial guess given by the neural network. These solutions are then compared to the given terminal condition to compute a loss function, where deep learning is then used to train the neural network that guesses the initial condition for the backward SDE. When the deep learning algorithm converges, the neural network's guess of the initial condition approaches the true initial condition. Thus, using deep learning one can solve FBSDEs by Monte-Carlo sampling which in turn can solve high-dimensional PDEs.

The SB problem is a Stochastic Optimal Control (SOC) problem, wherein the goal is to find the optimal control process (i.e., the optimal forward process) that can drive samples from a given initial distribution (p₀) to a given terminal distribution (p_{T}) (where T indicates the terminal time) in a finite amount of time.

Mathematically, the problem can be described as follows:

$$𝔼 \{ {\int }_{0}^{T} \frac{1}{2} {{‖ u ( x , t ) ‖}_{2}}^{2} dt \} \qquad ( 1 )$$

$${min}_{{u}_{t}} subject to the SDE dynamics : dx = f ( x , t ) dt + g u ( x , t ) dt + g dw ( t )$$

$$x ( t = 0 ) ∼ {p}_{0} ( {x}_{0} ) , x ( t = T ) ∼ {p}_{T} ( {x}_{T} )$$

where:
x(t) is a process that is referred to as the state (for image generation, x(t) can represent the process of starting from a clean image and undergoing corruption by noise over time);
dx(t) is a SDE that governs the stochastic evolution of the state;
u(x, t) is the control process; and
dw(t) is a collection of mutually independent Brownian motion increments (i.e., the noise increments) that enter the SDE and influence the evolution of x(t) at each time step.

The solution to the above SOC problem is the optimal control process u*(x, t). It is optimal with respect to the objective function [symbol] [·] shown in Equation (1), which aims to minimize the overall control effort. That allows one to optimally evolve a point x₀ drawn from p₀ to a point x_{T} drawn from p_{T} in a finite amount of time T.

Solving the above SB problem can be mathematically formulated as solving a set of coupled PDEs (hereafter referred to as SB-PDEs) given by:

$$\frac{\partial ϕ}{\partial t} = - {∇}_{x} {ϕ}^{T} f - \frac{1}{2} T r ( {g}^{2} {∇}_{x}^{2} ϕ ) \qquad ( 2 )$$

$$\frac{\partial \hat{ϕ}}{\partial t} = - div ( \hat{ϕ} f ) + \frac{1}{2} T r ( {g}^{2} {∇}_{x}^{2} \hat{ϕ} )$$

$$ϕ ( 0 , {x}_{0} ) \hat{ϕ} ( 0 , {x}_{0} ) = {p}_{0} ( {x}_{0} ) , ϕ ( T , {x}_{T} ) \hat{ϕ} ( T , {x}_{T} ) = {p}_{T} ( {x}_{T} )$$

where: div(·) refers to the divergence operator.

The solution to the above PDEs i.e., ϕ(t, xₜ) and \hat{ϕ}(t, xₜ) can then be used to compute the optimal control process u*(x, t)=g∇ₓ log ϕ.

In the context of deep generative modeling, the initial distribution (p₀) is generally set to be the data distribution (which, in practice, is unknown and one only has access to data samples from this distribution) and the terminal distribution (p_{T}) is set to be a simple distribution (generally Gaussian [symbol] (0, 1)), which is also referred to as the prior distribution. If one can successfully solve the above SB-PDEs, the solution can be used to generate synthetic data points corresponding to the original dataset by sampling from the prior distribution and evolving the “noisy” sample into a “clean” data point by going backwards in time using the following reverse-time SDE:

$$d x = f ( x , t ) dt - {g}^{2} {∇}_{x} log \hat{ϕ} dt + g d \hat{w} ( t ) , {x}_{T} ∼ {p}_{T} \qquad ( 3 )$$

It should be noted that the difference between a reverse-time SDE and a backward SDE is that the noise dŵ(t) that enters the reverse-time SDE is not the same as that which enters the forward SDE dw(t), while the same noise dw(t) enters both the forward and backward SDEs. This is a primary reason behind the mathematical complexity of solving backward SDEs. Reverse-time SDEs on the other hand can be solved similar to Forward SDEs using Monte Carlo sampling.

In the context of dataset-to-dataset interpolation, both the initial and terminal distributions are data distributions and solving the above SB problem yields a process that can optimally convert data points from one distribution into data points from another distribution. To convert a point x₀ from p₀ into a point from p_{T}, the optimal forward process is:

$$d x = f ( x , t ) dt + {g}^{2} {∇}_{x} log ϕ dt + g dw ( t ) , {x}_{0} ∼ {p}_{0} \qquad ( 4 )$$

and to convert a point x_{T} drawn from p_{T} into a data point distributed as per p₀, the optimal reverse process is:

$$d x = f ( x , t ) dt - {g}^{2} {∇}_{x} log \hat{ϕ} dt + g dw ( t ) , {x}_{T} ∼ {p}_{T} \qquad ( 5 )$$

However, in the context of high-dimensional data such as high-definition images, directly solving the aforementioned SB-PDEs is computationally expensive and suffers from the curse-of-dimensionality. One can therefore utilize the Nonlinear Feynman-Kac lemma to obtain a set of FBSDEs corresponding to the SB-PDEs. This connection may be leveraged as the set of FBSDEs is given by:

$$d x ( t ) = f ( x , t ) dt + g {Z}_{t} d t + g dw ( t ) \qquad ( 6 )$$

$${dY}_{t} = \frac{1}{2} {{‖ {Z}_{t} ‖}_{2}}^{2} dt + {Z}_{t}^{T} dw ( t )$$

$$d {\hat{Y}}_{t} = \frac{1}{2} {{‖ {\hat{Z}}_{t} ‖}_{2}}^{2} dt + di v ( g {\hat{Z}}_{t} - f ) d t + {\hat{Z}}_{t}^{T} {Z}_{t} d t + {\hat{Z}}_{t}^{T} d w ( t )$$

$$Y ( t = 0 , {x}_{0} ) + \hat{Y} ( t = 0 , {x}_{0} ) = log {p}_{0} ( {x}_{0} )$$

$$Y ( t = T , {x}_{T} ) + \hat{Y} ( t = T , {x}_{T} ) = log {p}_{T} ( {x}_{T} )$$

In the above equations, Zₜ, \hat{Z}ₜ, Yₜ and Ŷₜ are used as shorthand to indicate Z(x, t), \hat{Z}(x, t), Y(x, t) and Ŷ(x, t) for conciseness. For the remainder of the disclosure, this set of FBSDEs is referred to as the SB-FBSDEs.

The connection of the SB-FBSDEs to the SB-PDEs is given by the following equations (by applying the Nonlinear Feynman-Kac lemma):

$${Y}_{t} = log ϕ ( x , t ) \qquad ( 7 )$$

$${\hat{Y}}_{t} = log \hat{ϕ} ( x , t )$$

$${Z}_{t} = g {∇}_{x} {Y}_{t}$$

$${\hat{Z}}_{t} = g {∇}_{x} {\hat{Y}}_{t}$$

As mentioned herein, two existing algorithms may be used to solve the above set of FBSDEs. The first of the two has poor memory complexity and cannot be used for high-dimensional data. The second requires usage of a memory buffer, the computational graphs are discarded (and therefore crucial gradient paths are lost and the SDE is not end-to-end differentiable) and it requires an alternating training scheme which requires alternately solving the forward and reverse processes.

Aspects of the disclosure therefore utilizes a state-of-the-art reversible Heun SDE solver (which is an algebraically reversible SDE solver) along with the stochastic adjoint method (which is an optimize-then-discretize approach) to solve the SB-FBSDEs, which in turn can solve the SB problem. By combining an algebraically reversible SDE solver with the optimize-then-discretize approach, the SB-FBSDEs can be solved with O(1) (or constant) memory complexity and accurate gradient computation (equivalent to the discretize-then-optimize approaches). It should be noted that this approach to solve the SB-FBSDEs is not limited only to solving the SB problem but applies to all problems where the Nonlinear Feynman-Kac lemma is utilized to convert a PDE into a set of FBSDEs, such as for stochastic optimal control, where one wants to leverage deep learning to solve the set of FBSDEs which in turn solves the original Hamilton-Jacobi-Bellman PDE.

The first step to applying reversible Heun solver and the stochastic adjoint method is to convert the SB-FBSDEs from Itô to Stratonovich type. This involves adding a drift correction term to the Itô SDE to convert it into Stratonovich type. The Stratonovich version of the SB-FBSDEs may be of the form:

$$d {x}_{t} = f ( x , t ) dt + g {Z}_{t} d t + g ∘ d w ( t ) \qquad ( 8 )$$

$${dY}_{t} = \frac{1}{2} ( {{‖ {Z}_{t} ‖}_{2}}^{2} - div ( g {Z}_{t} ) ) d t + {Z}_{t}^{T} ∘ dw ( t )$$

$$d {\hat{Y}}_{t} = \frac{1}{2} {{‖ {\hat{Z}}_{t} ‖}_{2}}^{2} dt + d i v ( \frac{1}{2} g {\hat{Z}}_{t} - f ) d t + {\hat{Z}}_{t}^{T} {Z}_{t} d t + {\hat{Z}}_{t}^{T} ∘ dw ( t )$$

$$Y ( t = 0 , {x}_{0} ) + \hat{Y} ( t = 0 , {x}_{0} ) = log {p}_{0} ( {x}_{0} )$$

$$Y ( t = T , {x}_{T} ) + \hat{Y} ( t = T , {x}_{T} ) = log {p}_{T} ( {x}_{T} )$$

where the symbol º is used to indicate that the stochastic integral is evaluated in the Stratonovich sense.

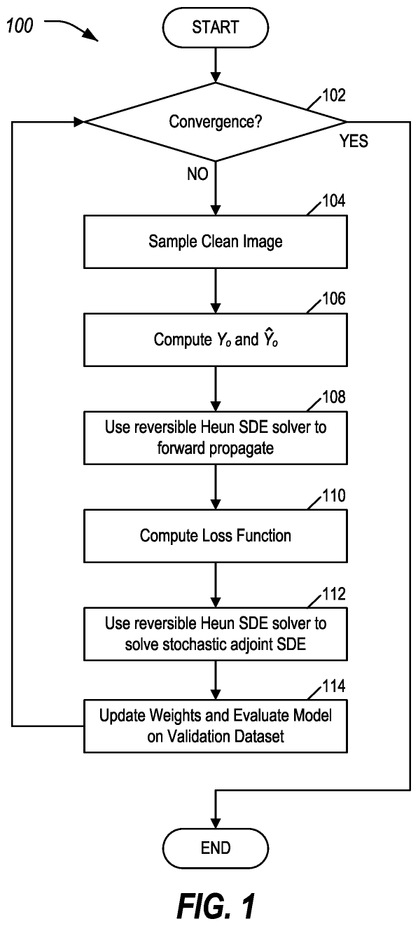

FIG. 1 illustrates an example process 100 for training a Schrodinger-Bridge-based generative model. Note that the symbol θ will be used to collectively represent all trainable parameters.

At operation 102, it is determined whether the algorithm has converged. If so, then the training is complete and the process 100 ends. If not, then the process 100 continues in a batched manner to iterate the remaining operations beginning with operation 104.

At operation 104, the process 100 samples a clean image x₀˜p₀, where p₀=p_{data}. This image may be from an input set of training data to be used to train the generative model.

At operation 106, the process 100 computes the initial values of Y₀ and Ŷ₀ using the sampled clean image and respective neural networks ξ_{θ} and \hat{ξ}_{θ} i.e., Y₀=ξ_{θ}(x₀) and Ŷ₀=\hat{ξ}_{θ}(x₀).

At operation 108, the process 100 feeds the initial values (i.e., x₀, Y₀ and Ŷ₀) along with the networks that predict □ₓYₜ and □ₓŶₜ (i.e., □ₓYₜ=ζ_{θ}(t, xₜ) and □ₓŶₜ=\hat{ζ}_{θ}(t, xₜ)) to the reversible Heun SDE solver to forward propagate xₜ, Yₜ and Ŷₜ. This is performed using the Stratonovich equations of the SB-FBSDEs of Equations (8), above to obtain the terminal values of the variables (i.e., x_{T}, Y_{T} and Ŷ_{T}).

At operation 110, the process 100 computes the loss function. This may, for example, be of the form [symbol] =mse (Y_{T}+Ŷ_{T}, log pₚᵣᵢₒᵣ (x_{T})), where mse stands for mean squared error.

At operation 112, using the reversible Heun SDE solver, the process 100 solves the stochastic adjoint SDE to compute the gradient

$$\frac{\partial ℒ}{\partial θ}$$

and update the weights θ. This may be performed using, e.g., any state-of-the-art variant of the Stochastic Gradient Descent (SGD) deep learning optimizer (such as the Adam optimizer) to train the collective weights θ vector for the networks ξ_{θ}, ξ_{θ}, ζ_{θ} and \hat{ζ}_{θ}.

At operation 114, the process 100 updates the weights of the model and evaluates the model on a validation dataset. This convergence metric is mathematically the same loss function as that used during training, but it is evaluated on a held-out portion of the training dataset, which is referred to herein as the validation dataset. After operation 114, the process 100 returns to 102 to check for convergence.

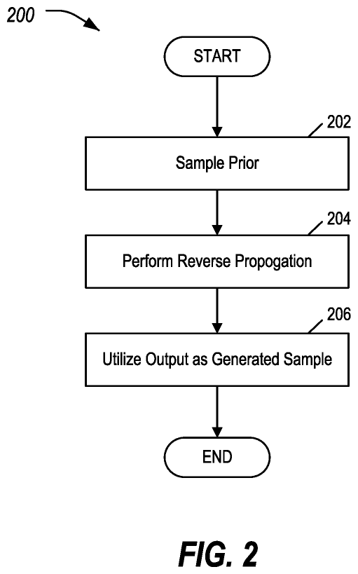

FIG. 2 illustrates an example process 200 for generating data using a trained Schrodinger-Bridge-based generative model. After learning the neural networks □ₓYₜ=ζ₀ (t, xₜ) and □ₓŶₜ= [symbol] (t, xₜ), let there be policies Zₜ=g□ₓYₜ and [symbol] =g□ₓ Ŷₜ where Yₜ=log ϕ(x, t) and Ŷₜ=log \hat{ϕ}(x, t). The generative procedure can be carried out by adopting [symbol] in the reverse-time SDE (dx=f(x, t)dt−g²□ₓ log \hat{ϕ}dt+g dŵ(t), x_{T}˜p_{T}). In an example, the trained Schrodinger-Bridge-based generative model may have been trained using the process 100 discussed above. The inputs to the process 200 may include pₚᵣᵢₒᵣ, as well as the policies Zₜ and [symbol] .
a. At operation 202, the process 200 samples data points from the prior distribution (i.e., X_{T}˜pₚᵣᵢₒᵣ). In an example, the prior distribution is initialized to be a simple distribution such as the standard normal distribution [symbol] (0, 1).

At operation 204, given the trained policies, the operation x₀←x_{T} is propagated is reverse time for t=T to t=0. This may be performed using dx=f(x, t)dt−g²□ₓ log \hat{ϕ}dt+g dŵ(t), x_{T}˜p_{T}.

At operation 206, x₀ is output as the generated synthetic data sample. The generated sample may then be used for various purposes.

Langevin sampling may also be adopted into the generative process 200 above to improve performance. This procedure may be referred to as the Langevin corrector. This procedure requires knowing the score function log □ₓpₜ(xₜ), which may be estimated using Zₜ+ [symbol] =log □ₓpₜ(xₜ).

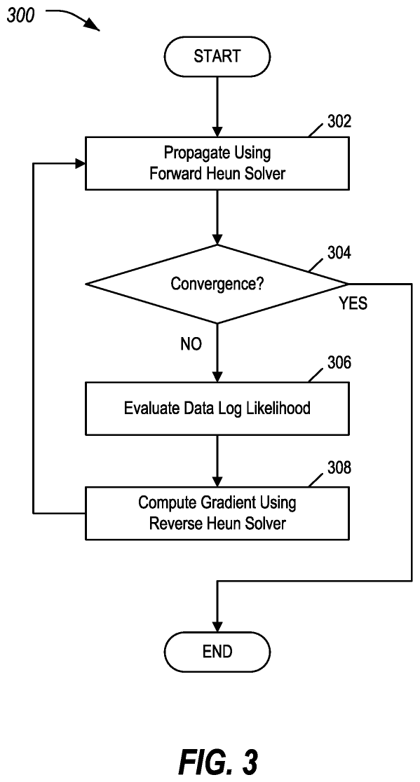

FIG. 3 illustrates an example process 300 for using a trained Schrodinger-Bridge-based generative model for outlier generation. In this process 300, the trained SB model is used to find the optimal starting point drawn from the prior p_{T} (i.e., the optimal x_{T}*) that would lead to a data point with low data likelihood (i.e., an outlier image) when the sample x_{T}* is reverse-propagated using dx=f(x, t)dt−g²□ₓ log \hat{ϕ}dt+g dŵ(t), x_{T}˜p_{T} from timestep t=T to t=0.

The inputs to the process 300 may include the trained network \hat{ζ}_{θ}, and a starting point drawn randomly from the prior distribution i.e., x_{T}˜p_{T}. The output may include an optimal point x_{T}*˜p_{T} that would lead to an outlier sample.

At operation 302, for t=T to t=0, x₀←x_{T}, the process 300 propagates using dx=f(x, t)dt−g²□ₓ log \hat{ϕ}dt+gºdŵ(t). This may be performed using the forward algorithm of the reversible Heun solver. It should be noted that this is a Stratonovich SDE, but because the diffusion term g is a constant, the drift correction term is 0 and it coincides with the Itô SDE.

At operation 304, it is determined whether the algorithm has converged. If so, then the generation is complete and the process 300 ends. If not, then the process 300 continues to operation 306.

At operation 306, the process 300 evaluates the data log likelihood of the generated x₀. This may be performed using Y₀+Ŷ₀=ζ_{θ}(x)+\hat{ζ}_{θ}(x)=log p₀ (x₀)= [symbol] , which gives a loss function to minimize.

At operation 308, the process 300 uses the reverse algorithm of the reversible Heun solver to compute the gradient

$$\frac{\partial ℒ}{\partial {x}_{T}}$$

and update x_{T} using gradient descent. After operation 308, the process 300 returns to operation 302 using the updated x_{T}.

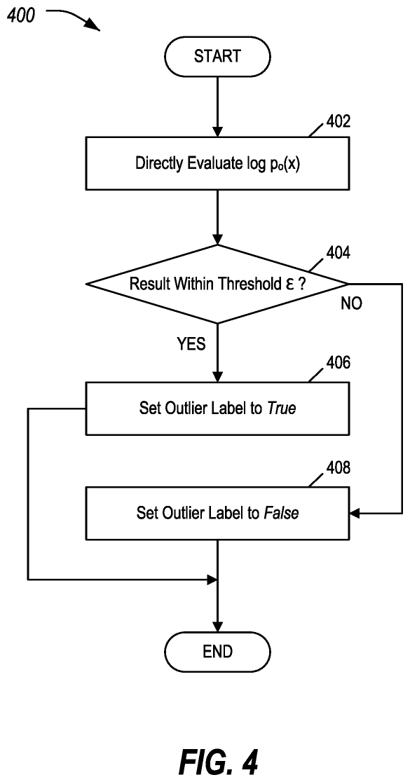

FIG. 4 illustrates an alternate example process 400 for using a trained Schrodinger-Bridge-based generative model for outlier generation. At the end of training, the learned data log-likelihood can be written as log p₀(x)=Y₀+Ŷ₀=ζ_{θ}(x)+\hat{ζ}_{θ}(x). Therefore, one can directly use log p₀(x) as a binary classification statistic for outliers, where high values of log p₀(x) indicate inliers (or normal examples) and low values of log p₀(x) indicate outliers.

The inputs to this process 400 may include a query x, trained networks ζ_{θ}, and \hat{ζ}_{θ}, and threshold ε. The output may include an outlier label y.

At operation 402, the process 400 directly evaluates log p₀(x) as a binary classification statistic for outliers. For example, the process 400 may evaluate log p₀(x)=Y₀+Ŷ₀=ζ_{θ}(x)+\hat{ζ}_{θ}(x).

At operation 404, the process 400 determines whether (log p₀(x)<ε). If so, the process 400 proceeds to operation 406 to Set y=True. Otherwise, the process 400 proceeds to operation 408 to Set y=False.

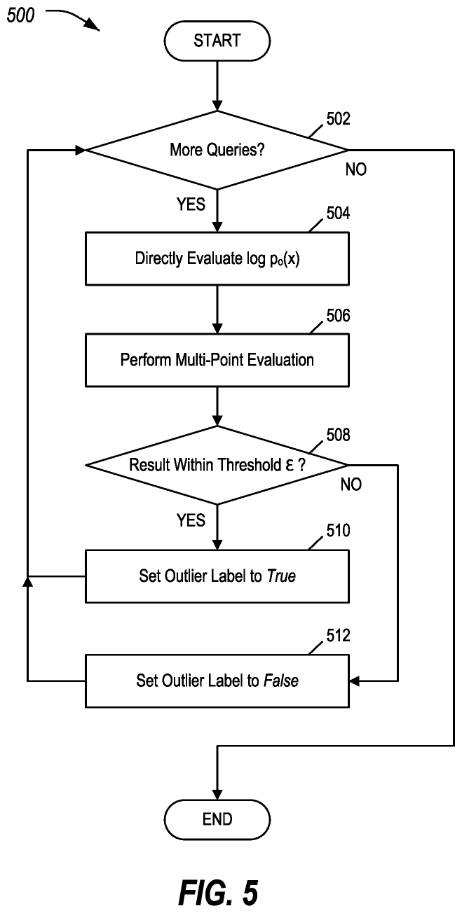

FIG. 5 illustrates yet another example process 500 for using a trained Schrodinger-Bridge-based generative model for outlier generation. Here, the data log-likelihood can also be used in a typicality test-based outlier detection scheme, which can be applied to multi-data point queries.

The inputs to this process 500 may include queries x₀, x₁, . . . , xₙ, trained networks ζ_{θ}, and \hat{ζ}_{θ}, and threshold ε. As before, the output may include an outlier label y.

At operation 502, the process 500 iterates for each query i in {0 . . . n}, to perform the following operations.

At operation 504, the process 500 directly evaluates log p₀(x) as a binary classification statistic for outliers. Similar to the process 400, the process 500 may evaluate yᵢ=log p₀(x)=Y₀+Ŷ₀=ζ_{θ}(xᵢ)+\hat{ζ}_{θ}(xᵢ), here for the current i.

At operation 506, the process 500 performs a multi-data point evaluation. Here, the process 500 evaluates h=Σᵢ₌₁ⁿ|yᵢ−Σᵢ₌₁ⁿyᵢ|. Based on the evaluation, at operation 508 the process 500 determines whether (h<ε). If so, the process 500 proceeds to operation 510 to Set y=True. Otherwise, the process 500 proceeds to operation 512 to Set y=False.

The process 500 continues until the iteration is complete. Since log p₀(x) computations simply involve two neural network evaluations (which may be performed in parallel), both processes 400 and 500 are very fast and lightweight to compute.

Thus, by using the state-of-the-art optimize-then-discretize reversible Heun SDE solvers to solve FBSDEs, which in turn solve the corresponding SB problem, the disclosed approach provides useful improvements.

First, improved modeling flexibility is provided. The SDE modeled by the disclosed approach is end-to-end differentiable, because it does not discard the computational graphs. This is of great importance in diffusion-based generative modeling wherein a nonlinear term can be learned in the forward process that forces the forward trajectories to be distributed as per the prior distribution (i.e., it forces the terminal states to have a high likelihood with respect to the prior distribution). This allows reducing the number of diffusion steps required for generation thereby leading to faster generation times and lower computation per sample.

Second, fast and explicit log-likelihood modeling is provided. As compared to earlier approaches that use diffusion models to estimate the log-likelihood of new data points, the disclosed approach provides the log-likelihood in a single evaluation of the neural networks used to predict the data log-likelihood.

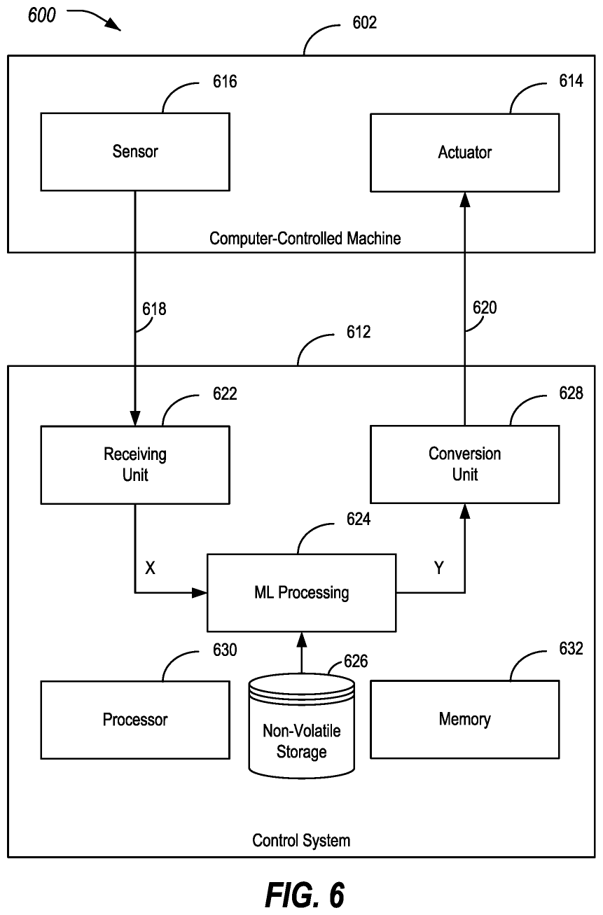

FIG. 6 depicts a schematic diagram of an interaction between a computer-controlled machine 602 and a control system 612. The computer-controlled machine 600 may implement aspects of the training and use of Schrodinger-Bridge-based generative models. Referring to FIG. 6, and with reference to FIGS. 1-5, the processes 100-500 discussed herein may be performed in the context of such a computer-controlled machine 602 and control system 612. The computer-controlled machine 602 includes actuator 614 and sensor 616. Actuator 614 may include one or more actuators and sensor 616 may include one or more sensors. Sensor 616 is configured to sense a condition of computer-controlled machine 602. Sensor 616 may be configured to encode the sensed condition into sensor signals 618 and to transmit sensor signals 618 to control system 612. Non-limiting examples of sensor 616 include video, radar, LiDAR, ultrasonic and motion sensors. In one embodiment, sensor 616 is an optical sensor configured to sense optical images of an environment proximate to computer-controlled machine 602.

Control system 612 is configured to receive sensor signals 618 from computer-controlled machine 602. As set forth below, control system 612 may be further configured to compute actuator control commands 620 depending on the sensor signals and to transmit actuator control commands 620 to actuator 614 of computer-controlled machine 602.

As shown in FIG. 6, control system 612 includes receiving unit 622. Receiving unit 622 may be configured to receive sensor signals 618 from sensor 616 and to transform sensor signals 618 into input signals X. In an alternative embodiment, sensor signals 618 are received directly as input signals X without receiving unit 622. Each input signal x may be a portion of each sensor signal 618. Receiving unit 622 may be configured to process each sensor signal 618 to product each input signal x. Input signal x may include data corresponding to an image recorded by sensor 616.

Control system 612 includes machine learning (ML) processing 624. ML processing 624 may be configured to learn, classify, infer, generate, etc. using one or more models such ash those described in detail above. In an example, ML processing 624 is configured to determine output signals Y from input signals X. Each output signal y includes information that assigns one or more labels to each input signal X. ML processing 624 may transmit output signals Y to conversion unit 628. Conversion unit 628 is configured to convert output signals Y into actuator control commands 620. Control system 612 is configured to transmit actuator control commands 620 to actuator 614, which is configured to actuate computer-controlled machine 602 in response to actuator control commands 620. In another embodiment, actuator 614 is configured to actuate computer-controlled machine 602 based directly on output signals Y.

Upon receipt of actuator control commands 620 by actuator 614, actuator 614 is configured to execute an action corresponding to the related actuator control command 20. Actuator 614 may include a control logic configured to transform actuator control commands 620 into a second actuator control command, which is utilized to control actuator 614. In one or more embodiments, actuator control commands 620 may be utilized to control a display instead of or in addition to an actuator.

In another embodiment, control system 612 includes sensor 616 instead of or in addition to computer-controlled machine 602 including sensor 616. Control system 612 may also include actuator 614 instead of or in addition to computer-controlled machine 602 including actuator 614.

As shown in FIG. 6, control system 612 also includes processor 630 and memory 632. Processor 630 may include one or more processors. Memory 632 may include one or more memory devices. The classifier 624 (e.g., ML algorithms) of one or more embodiments may be implemented by control system 612, which includes non-volatile storage 626, processor 630 and memory 632.

Non-volatile storage 626 may include one or more persistent data storage devices such as a hard drive, optical drive, tape drive, non-volatile solid-state device, cloud storage or any other device capable of persistently storing information. Processor 630 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 632. Memory 632 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 630 may be configured to read into memory 632 and execute computer-executable instructions residing in non-volatile storage 626 and embodying one or more ML algorithms and/or methodologies of one or more embodiments. Non-volatile storage 626 may include one or more operating systems and applications. Non-volatile storage 626 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 630, the computer-executable instructions of non-volatile storage 626 may cause control system 612 to implement one or more of the ML algorithms and/or methodologies as disclosed herein. Non-volatile storage 626 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

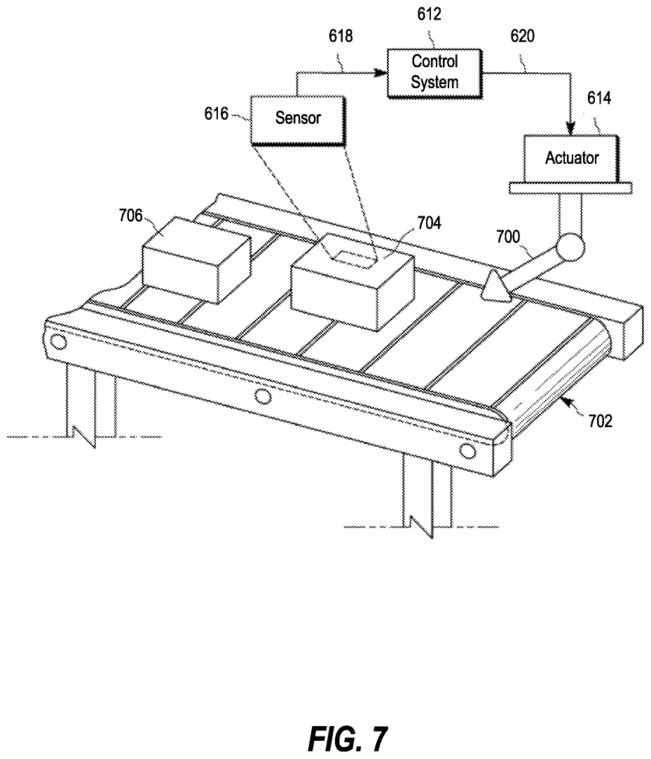

FIG. 7 illustrates an example manufacturing system 700 for use in anomaly detection and/or generation of synthetic anomalous data. The system 700 may be configured to control a manufacturing machine 702, such as a punch cutter, a cutter or a gun drill, etc., such as part of a production line.

The system 700 may be configured to control an actuator 614, which is configured to control the manufacturing machine 702. A sensor 616 of the system 700 may be configured to capture one or more properties of a manufactured product 704. ML processing 624 may be configured to determine a state of the manufactured product 704 from one or more of the captured properties. An actuator 614 may be configured to control the system 700 (e.g., a manufacturing machine) depending on the determined state of the manufactured product 704 for a subsequent manufacturing step of the manufactured product 704. In particular, the actuator 614 may be configured to control functions of system 100 (e.g., the manufacturing machine) on subsequent manufactured product 706 of the system 700 (e.g., the manufacturing machine) depending on the determined state of the manufactured product 704.

The framework discussed in this disclosure may be used for anomaly detection in the system 700. The framework may enable superior data log-likelihood computation speed, achieving O(1) computational and memory complexity versus the O(N) attained in earlier approaches. This can be used to quickly identify unlikely data points, e.g., in data received from the sensor 616, which may be essential for low-latency anomaly detection by the system 700. This is also beneficial for deploying such anomaly detection capability on embedded devices or devices with low compute capability, such as those in a manufacturing system 700. Anomaly detection may be useful in other contexts as well, such as fraud prevention tasks.

In another example, the framework may be useful for generating synthetic anomalous data. Because Schrodinger Bridges (SBs) find the most optimal path to map points from one data distribution to another, the disclosed approach may be used to solve SBs to transform normal (i.e., OK) data distributions into their corresponding anomalous (i.e., Not-OK) data distributions. An example is in the manufacturing setting where the number of OK examples far supersede the amount of Not-OK examples because manufacturing defects are not very common, but when they do occur they have signification economic and safety ramifications. This is problematic for classifiers that are trained on such data to identify anomalous parts in manufacturing plants. A SB model can be used to synthesize Not-OK examples thereby increasing the training data for the classifiers leading to robust classification of anomalous parts.

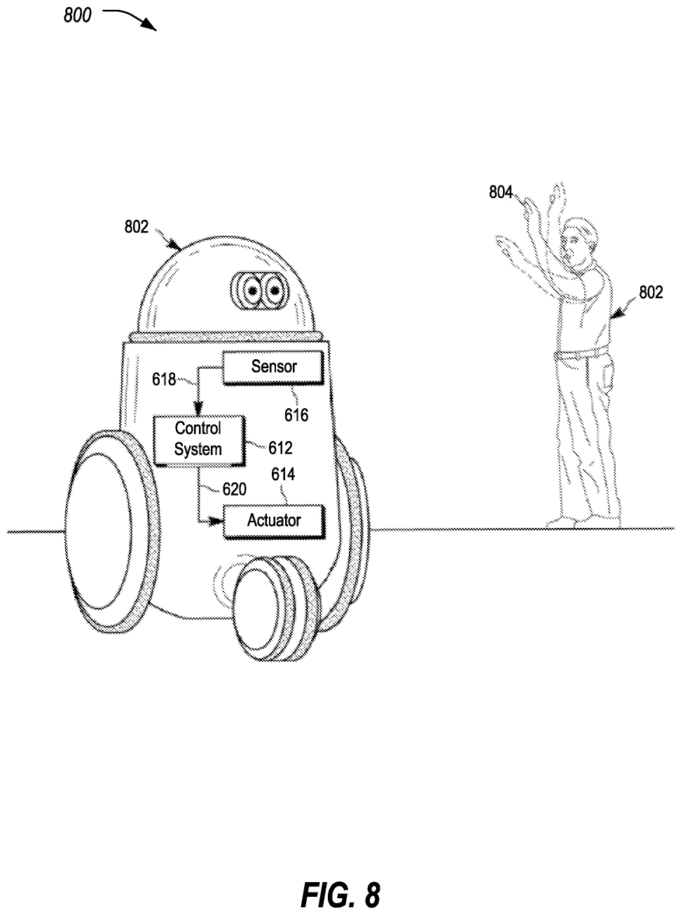

FIG. 8 depicts a schematic diagram of a control system 612 configured to control a robotic assistant 800. The control system 612 may be configured to control an actuator 614, which is configured to command one or more aspect of the robotic assistant 800. The robotic assistant 800 may be configured to control any of various other devices, such as a domestic appliance, a washing machine, a stove, an oven, a microwave or a dishwasher.

The control system 612 may include sensors 616 of various types. For example, the sensors 616 may include an optical sensor and configured to receive video images of gestures 804 of a user 802. Or, the sensors 616 may include an audio sensor configured to receive a voice command of the user 802. It should be noted that these sensor types are only examples, and various types of sensors may be used.

The control system 612 of the robotic assistant 802 may be configured to determine actuator control commands 812 configured to control the operation of the robotic assistant 802. The control system 612 may be configured to determine the actuator control commands 620 in accordance with sensor signals 618 received from the sensors 616. The robotic assistant 802 may be configured to transmit the sensor signals 618 to the control system 612. ML processing 624 of the control system 612 may be configured to execute a gesture recognition algorithm to identify a gesture 818 performed by the user 810, to determine the actuator control commands 620, and to transmit the actuator control commands 620 to the actuator 614. The ML processing 624 may be configured to retrieve information from non-volatile storage in response to identification of the gesture 804 and to output the retrieved information in a form suitable for reception by the user 802.

Solution to FBSDEs for long-horizon control may be useful for such a robotic assistant 802. Because the RH solver can handle longer time horizons owing to the O(1) memory complexity, it can be used to solve systems of FBSDEs that correspond to optimal control problems for real world robotics tasks that require long planning horizons. An example would be for the robotic assistant 802 to operate in the kitchen, tasked with cooking a desired dish. In this case, the robotic assistant 802 is required to plan over a long time-horizon and is required to break down the task into sub-tasks with sub-goals such as fetching the required ingredients, processing the raw ingredients (cutting, peeling, etc.), adding the ingredients to pot/pan at the right time, regulating the heat source, etc. Prior techniques fails to handle long time-horizons because the resulting computational graphs do not fit in memory of standard GPUs thereby making it either impossible or requiring expensive GPU hardware to train.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for training a Schrodinger-Bridge-based generative model, comprising:
sampling a clean example to be learned, the clean example being from an input set of training data to be used to train the generative model;
computing initial values using the sampled clean example and the generative model;
feeding the initial values from the clean example and the computed initial values to a Reversible-Heun (RH) Stochastic Differential Equation (SDE) solver to forward propagate using Schrodinger Bridge Forward-Backward Stochastic Differential Equations (SB-FBSDEs) computed for the generative modeling problem, producing predicted output values;
computing a loss function to compares true values and the predicted output values; and
using a reverse algorithm of the RH SDE solver, solving the stochastic adjoint SDE to compute the gradient and update the weights of the generative model.

2. The method of claim 1, wherein the clean example is a two-dimensional image.

3. The method of claim 1, further comprising utilizing the Nonlinear Feynman-Kac lemma to obtain the SB-FBSDEs corresponding to Schrodinger Bridge Partial Differential Equations (SB-PDEs) of the generative modeling problem.

4. The method of claim 1, further comprising using a variant of the Stochastic Gradient Descent (SGD) deep learning optimizer to update the weights of the deep generative model using the gradients computed using the reverse algorithm of the RH SDE solver.

5. The method of claim 4, wherein the SGD deep learning optimizer is the Adam optimizer.

6. The method of claim 1, further comprising repeating the training a plurality of times until convergence.

7. The method of claim 1, further comprising using the generative model, once trained, for generating a data sample.

8. The method of claim 1, further comprising using the trained Schrodinger-Bridge-based generative model for outlier generation by finding a starting point drawn from a prior distribution that leads to a data point with low data likelihood.

9. The method of claim 8, wherein the starting point is found by using the loss function that evaluates the data-log likelihood.

10. The method of claim 8, wherein the starting point is found by using a learned data log-likelihood loss function of the Schrodinger-Bridge-based generative model.

11. The method of claim 8, further comprising using the trained generative model to predict the data-log likelihood which is subsequently used directly as a classifier of outlier status based on a predefined outlier threshold value.

12. The method of claim 8, further comprising using the data log-likelihood in a typicality test-based outlier detection scheme applied to multi-data point queries.

13. A system for training a Schrodinger-Bridge-based generative model, comprising:
one or more computing devices configured to:
sample a clean image to be learned, the clean image being from an input set of training data to be used to train the generative model;
compute initial values using the sampled clean image and the generative model;
feed the initial values from the clean image and the computed initial values to a Reversible-Heun (RH) Stochastic Differential Equation (SDE) solver to forward propagate using Schrodinger Bridge Forward-Backward Stochastic Differential Equations (SB-FBSDEs) computed for the generative model, producing predicted output values;
compute a loss function to compares the initial values and the predicted output values; and
using a reverse of the RH SDE solver, solve the stochastic adjoint SDE to compute the gradient and update the weights of the generative model.

14. The system of claim 13, wherein the clean example is a two-dimensional image.

15. The system of claim 13, wherein the one or more computing devices are further configured to utilize the Nonlinear Feynman-Kac lemma to obtain the SB-FBSDEs corresponding to Schrodinger Bridge Partial Differential Equations (SB-PDEs) of the generative model.

16. The system of claim 13, wherein the one or more computing devices are further configured to use a Stochastic Gradient Descent (SGD) deep learning optimizer to compute the gradient.

17. The system of claim 16, wherein the SGD deep learning optimizer is an Adam optimizer.

18. The system of claim 13, wherein the one or more computing devices are further configured to repeat the training a plurality of times until convergence.

19. The system of claim 13, wherein the one or more computing devices are further configured to use the generative model, once trained, for generating a data sample.

20. The system of claim 13, wherein the one or more computing devices are further configured to use the trained Schrodinger-Bridge-based generative model for outlier generation by finding a starting point drawn from a prior distribution that leads to a data point with low data likelihood.

21. The system of claim 20, wherein the starting point is found by using the loss function that evaluates the data-log likelihood.

22. The system of claim 20, wherein the starting point is found by using a learned data log-likelihood loss function of the Schrodinger-Bridge-based generative model directly as a classifier of outlier status based on a predefined outlier threshold value.

23. The system of claim 20, wherein the one or more computing devices are further configured to use the trained generative model to predict the data-log likelihood which is subsequently used directly as a classifier of outlier status based on a predefined outlier threshold value.

24. The system of claim 20, wherein the one or more computing devices are further configured to use the data-log likelihood in a typicality test-based outlier detection scheme applied to multi-data point queries.

25. A non-transitory computer-readable medium comprising instructions for training a Schrodinger-Bridge-based generative model that, when executed by one or more computing devices, cause the one or more computing devices to perform operations including configured to:
sample a clean image to be learned, the clean image being from an input set of training data to be used to train the generative model;
compute initial values using the sampled clean image and the generative model;
feed the initial values from the clean image and the computed initial values to a reversible Heun Stochastic Differential Equation (SDE) solver to forward propagate using Schrodinger Bridge Forward-Backward Stochastic Differential Equations (SB-FBSDEs) computed for the generative model, producing predicted output values;
compute a loss function to compares the initial values and the predicted output values; and
using a reverse of the reversible Heun SDE solver, solve the stochastic adjoint SDE to compute the gradient and update the weights of the generative model.
